(19) United States
(12) Patent Application Publication
(10) Pub. No.: US 2018/0359365 A1
(43) Pub. Date: Dec. 13, 2018

(54) Server System for Preparation of User-Specific Information for Users in at Least One Com-munication Network

(71) Applicant: Siemens Aktiengesellschaft, Muenchen (DE)

(72) Inventors: Thomas Burgard, Muenchen (DE); York Hochheim, Muenchen (DE); Axel Kreten, Puchheim (DE)

(73) Assignee: Siemens Aktiengesellschaft, Muenchen (DE)

(21) Appl. No.: 16/106,516

(22) Filed: Aug. 21, 2018

Related U.S. Application Data
(63) Continuation of application No. 10/203,429, filed on Dec. 2, 2002, now abandoned.

(30) Foreign Application Priority Data
Feb. 10, 2000 (DE) 100 05 776.4

(51) Int. Cl. H04M 3/53; H04M 7/00

(52) U.S. Cl. CPC H04M 3/5307; H04M 7/006

(57) ABSTRACT

The invention relates to a server system, for preparation of user-specific information for users in at least one communication network, such as, for example, the internet. According to the invention, the server system comprises a collection device, for collecting status information relating to the status of mailbox messages, in at least one service-specific mailbox server, with at least one service-specific and communication network-specific message format, for example, e-mail, voice-mail, and fax-mail and a registration device for registering the activity of a user on at least one communication terminal, in at least one of the at least one communication networks. The registration device furnishes one of the at least one active users on the at least one communication network with the status information from the collecting device, on the at least one communication terminal, which relates to mailbox messages, stored in the at least one mailbox server, for said user. The invention further relates to a corresponding method for preparation of information for users in at least one communication network.

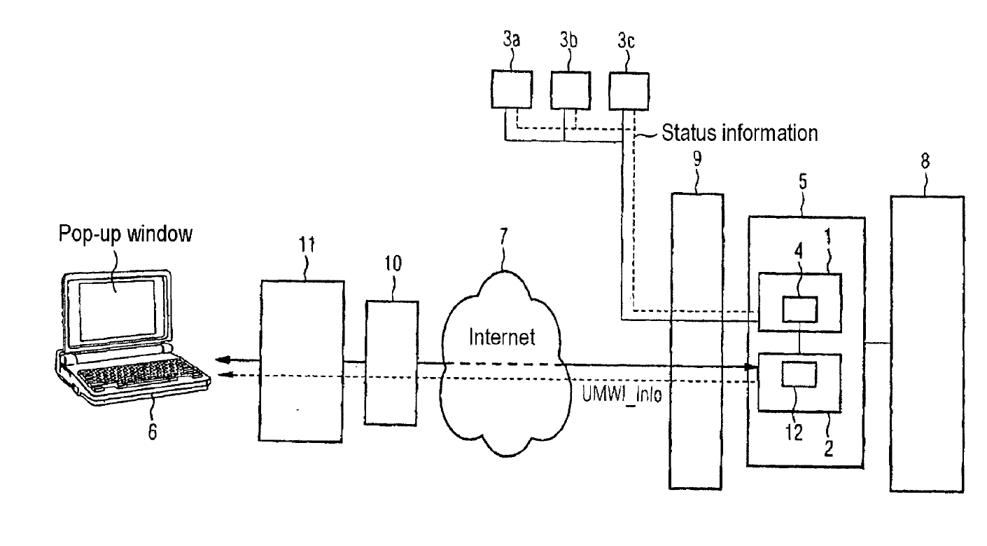

### CROSS-REFERENCE TO RELATED APPLICATIONS

This application is a U.S. National Stage Application of International Application No. PCT/DE01/00505 filed Feb. 9, 2001, which designates the United States of America, and claims priority to DE Application No. 100 05 776.4 filed Feb. 10, 2000, the contents of which are hereby incorporated by reference in their entirety.

### TECHNICAL FIELD

The present invention relates to a server system for providing subscriber-specific information for subscribers in at least one communications network. The present invention in this case relates in particular to the provision of status information relating to the status of mailbox messages from at least one service-specific mailbox server, using at least one service-specific message format and at least one communications-network-specific message format.

### BACKGROUND

The use of mailboxes which are in each case configured for one information service—for example for processing speech information, fax information, e-mail information and the like—is becoming ever wider. Service-specific mailbox messages such as these are generally in each case stored in a mailbox server, in which case the relevant subscriber for whom newly arriving mailbox messages are intended must either himself regularly check and, if appropriate, call up his mailbox messages, or the subscriber is informed by means of status information of the arrival of a new mailbox message on his associated telephone set, for example a mobile telephone, on the landline telephone at home, or in the office. Once a subscriber has been informed in this way of a newly arriving mailbox message, he can retrieve it from the respective mailbox server and can listen to it or display it on his telephone set.

By way of example, the MWI (Message Waiting Indication) service feature which is defined in the ETSI standard (European Telecommunication Standard Institute) provides the status information that a new mailbox message is waiting only from a separate mailbox server in each case (voicemail, fax mail, e-mail etc). This status information is displayed on the telephone terminal (analog telephone, ISDN telephone, mobile telephone or the like) of the relevant subscriber. Depending on the display capability of the telephone terminal and the signaling capability of the associated switching center to the telephone terminal (analog telephone with additional signaling, for example by means of frequency shift keying FSK or an ISDN telephone with a functional protocol or stimulus protocol), the display may be simple, such as “message waiting” or more extensive, with, for example, the number and type of newly arriving mailbox messages, the date and time of receipt and the like being displayed.

The system outlined above for automatic provision of status information relating to the status of the mailbox messages has the disadvantage that the status information is provided only on telephone sets.

The invention is based on the object of improving the provision of status information.

This object is achieved by a server system according to the features of patent claim 1, and by a method according to the features of patent claim 8.

### SUMMARY

The major aspect of the server device according to the invention for providing subscriber-specific information for subscribers in at least one communications network is that a collecting device for collecting subscriber-specific status information relating to the status of mailbox messages from at least one service-specific mailbox server is arranged using at least one service-specific and communications-network-specific message format, with the subscriber-specific status information relating to mailbox messages which are stored for this subscriber in the at least one mailbox server. Furthermore, a registration device for registration of the activity of a subscriber at least one communications terminal is arranged in at least one of the at least one communications networks, with the registration device transmitting the collected status information from the collecting device via at least one of the at least one communications networks to at least one of the at least one communications terminals of the respective active subscriber.

The present invention thus allows status information to be displayed in a simple and efficient manner on a communications terminal, for example a computer, at which a subscriber is active at that time in a communications network, such as the Internet. If the display medium is a computer, this allows a comprehensive and extensive display of the states of the mailboxes for the respective subscriber to be produced on its screen. The subscriber may also be associated with a number of communications networks, that is to say the subscriber has arranged a number of suitable communications terminals in a number of communications networks—for example the Internet and a mobile and/or wire-connected telephone network. The server system according to the invention can in this case be implemented, for example, on a separate server, which is coupled to a digital switching center for a telephone network. The status information for the mailboxes of a subscriber is advantageously provided with the aid of the “Message Waiting Indication” service feature, which has already been defined in the ETSI standard, by means of which the status information relating to the mailboxes of a subscriber is provided in a simple and efficient manner via at least one communications network, such as the Internet, which is connected to the server system according to the invention. By way of example, the subscriber may also be associated with a number of organizationally or physically separate mobile communications networks, with mailbox messages for the subscriber being stored in each mobile radio network.

The collecting device advantageously provides the status information for the registration device via a user program interface.

The communications network is advantageously the Internet or a mobile or wire-connected telephone network, with the registration device having a databank with identifiers and/or addresses of possible subscribers. When an active subscriber registers, the registration device can in this case identify whether the subscriber is active from his own communications terminal which is registered for him—for example a computer—for example his own E164#, or on some other computer, for example some other E164#, using his identifier which is registered for him, and can supply the status information to the corresponding computer.

The registration device advantageously supplies the status information to the respective communications terminal as soon as it receives this status information from the collecting device. Alternatively, the registration device may not supply the status information to the respective communications terminal—for example a computer—until it has received a corresponding request from the respective computer.

The present invention thus allows comprehensive and extensive provision of the collected status information of mailbox messages for a subscriber at at least one communications terminal.

### BRIEF DESCRIPTION OF THE DRAWINGS

The present invention will be explained in more detail in the following text using a preferred exemplary embodiment and with reference to the attached single FIGURE, which illustrates the schematic layout of a communications system having, a server system according to the invention.

The FIGURE shows a general schematic illustration of a communications system in which a collecting device 1 according to the invention is implemented in a server unit 5 for collecting status information relating to the status of mailbox messages from a number of mailbox servers 3a, 3b, 3c using different message formats, and a registration device 2 is implemented in a server unit 5 for registration of the activity of a subscriber at a computer 6 in a communications network 7.

### DETAILED DESCRIPTION

The collecting device 1 is connected to a number of mailbox servers 3a, 3b, 3c, with the first mailbox server, for example, being used for buffer-storage of voicemail, the second mailbox server 3b being used for buffer-storage of fax mails, and the third mailbox server 3c being used for buffer-storage of e-mails. The mailbox servers are also connected to a communications network, such as the Internet 7 and/or a telephone network, via which appropriate mailbox messages are passed to it. As soon as a new mailbox message arrives in one of the mailbox servers 3a, 3b, 3c, an appropriate status information item is sent to the collecting device 1. Alternatively, the collecting device 1 may check the mailbox servers 3a, 3b, 3c at regular intervals.

The collecting device 1 has a user program interface 4 via which the status information received from the mailbox servers 3a, 3b, 3c is converted to an appropriate format and is supplied to the registration device 2. The registration device 2 has a databank 12 with the identifiers and the addresses of the registered and authorized subscribers and their computers. As soon as a subscriber is active in the Internet 7, for example at the computer 6, the activity of this subscriber is registered by the registration device 2. New status information which the registration device 2 receives from the collecting device 1 is then provided by the registration device 2 for the subscriber at the computer 6, for example in the form of a pop-up window. The status information in this case includes all the information from all the mailboxes which are associated with that subscriber. In this case, the status information can be provided for the subscriber either automatically, as soon as it is supplied from the collecting device to the registration device 2, or the subscriber and/or the computer 6 can check the registration device 2 regularly using an automated method.

The status information which is displayed to the subscriber on the computer 6 includes, as mentioned, an overall statement relating to the status of the mailboxes associated with the subscriber in the mailbox servers 3a, 3b, 3c, in which case the scope of the status information may vary. The status information which is provided for subscriber at the computer 6 may, for example, include only a simple note that one or more new mailbox messages have arrived in the mailbox servers 3a, 3b, 3c and can be called up. Alternatively, a more extensive display may be provided of all the new mailbox messages including the type, the number, the date of receipt, the time of receipt, the sender etc.

Furthermore, it is possible to provide for one or more specific mailbox messages to be called up directly from the display of the status information.

The computer 6 which is used to display the status information to the respective subscriber from his mailboxes may be either the computer which is registered for this subscriber or some other computer, on which the computer is active using its own personal identifier.

In the illustrated example, the server unit 5, which contains the collecting device 1 according to the invention and the registration device 2 according to the invention, is coupled to a digital switching center 8, for example to an EWSD switching center, which is in turn part of a telephone network. The server unit 5 in this case optionally produces a connection to the Internet 7, via a fire wall 9. The computer 6, on which a subscriber is displayed his status information, is connected to the Internet 7 via a local node 10 and a switching point 11.

The collecting device 1 and the registration device 2 are, for example, implemented in the form of software programs in the server system 5. Alternatively, the collecting device 1 may also, however, be implemented in the digital switching center 8. In this case, the collecting device 1 carries out the functions of the MWI service feature as defined in the ETSI standard, with the aid of which all the information relating to the status of mailbox messages from a number of mailbox servers 3a, 3b, 3c using different message formats is provided for a respective subscriber. The server unit 5 is, for example, a so-called open service unit, which produces a connection between a telephone network and the Internet and allows mutual provision of respective services.

1-22. (canceled)

23. Server system for providing subscriber-specific information for subscribers in at least one communications network, characterized by:
a collecting device for collecting subscriber-specific status information, which relates to mailbox messages which are stored for a subscriber in at least one service-specific mailbox server; and
a registration device for registration of the activity of a subscriber at at least one communications terminal in at least one communication network, for reception of the subscriber-specific status information from the collecting device, and for transmission of the subscriber-specific status information to the respective subscriber, wherein
the registration device is configured to automatically send the status information received for a subscriber to at least one communication terminal when it has registered this subscriber as being active at the at least one communication terminal.

24. The server system according to claim 23, characterized in that the collecting device is configured to provide the status information for the registration device via a user program interface.

25. The server system according to claim 23, characterized in that the at least one communications network:
is the Internet or represents a communications network which is based on TCP/IP protocols, or is in the form of a packet-oriented or cell-oriented communications network, with the registration device having a databank with identifiers and/or addresses of possible subscribers, or
being a mobile or wire-connected telephone network, with telephone numbers of possible subscribers being stored in the databank or in a further databank.

26. The server system according to claim 23, characterized in that the at least one communications terminal is in the form of a wire-connected or wire-free telephone terminal, or of a computer or of a multimedia communications terminal.

27. The server system according to claim 26, characterized in that the registration device is configured to identify, on registration of an active subscriber, whether the subscriber is active from his own computer, which is registered for him, or on some other computer using his identifier, which is registered for him.

28. The server system according to claim 23, characterized in that the registration device is configured to supply the subscriber-specific status information to the at least one communications terminal as soon as it receives this status information from the collecting device.

29. A method for providing subscriber-specific information for subscribers in at least one communications network, according to which:
subscriber-specific status information which relates to mailbox messages which are stored for a subscriber in at least one service-specific mailbox server is collected by a collecting device,
the activity of a subscriber at at least one communication terminal in at least one communication network is registered by a registration device, subscriber-specific status information is received by the collecting device, and subscriber-specific status information is transmitted to the respective subscriber, wherein
when the registration device has registered a subscriber as being active at at least one communication terminal, the status information received for this subscriber is automatically sent to the at least one communication terminal.

30. The method of claim 29, characterized in that subscriber-specific, service-specific mailbox messages are stored in at least one of the at least one communications networks using at least a partially different communications-network-specific and/or service-specific message format.

31. The method of claim 29, characterized in that the service-specific mailbox messages are stored in at least one mailbox server which provides at least one information service, with the mailbox messages having a message format which is matched to the respective information service.

32. The method of claim 29, characterized in that the status information is collected from
mailbox messages of an information service within a communications network, and/or
mailbox messages of a number of information services within a communications network, and/or
mailbox messages of an information service within a number of communications networks, and/or
mailbox messages of a number of information services within a number of communications networks.

33. The method of claim 29, characterized in that the information service comprises
a service for storage and for indication and transmission of fax information, and/or
a speech memory service for storage and for indication and transmission of speech information, and/or
a message memory service for storage and for indication and transmission of electronic messages or e-mails or SMS messages and is implemented in at least one of the at least one communications networks.

34. The method of claim 29, characterized in that the subscriber-specific status information is output or can be called up via at least one communications terminal which is matched to the respective communications network and is associated with the respective subscriber.

35. The method of claim 34, characterized in that the subscriber-specific status information is output or can be called up via a wire-connected or wire-free telephone terminal, or via a computer or via a multimedia communications terminal.

36. The method of claim 29, characterized in that any activity of the respective subscriber in at least one of the at least one communications networks is detected and/or registered,
in that the subscriber-specific status information is transmitted to the respective subscriber who is active in the respective communications network.

37. The method of claim 29, characterized in that the collected status information is provided via a user program interface.

38. The method of claim 29, characterized in that the at least one communications network
is the Internet or represents a communications network which is based on TCP/IP protocols, or is in the form of a packet-oriented or cell-based communications network, with identifiers and/or addresses of possible subscribers being stored in a databank, or
is a mobile or wire-connected telephone network, with telephone numbers of possible subscribers being stored in the databank or in a further databank.

39. The method of claim 29, characterized in that the status information which is collected for one subscriber is transmitted to the at least one identifier and/or address and/or telephone number which addresses the respective subscriber in at least one of the at least one communications networks and is correspondingly stored.

40. The method of claim 36, characterized in that, on registration of an active subscriber, the registration process identifies whether the subscriber is active from his own computer, which is registered for him, or on some other computer using his identifier which is registered for him, and the subscriber-specific status information is then supplied to the corresponding computer.

41. The method of claim 32, characterized in that the subscriber-specific status information is supplied to the respective communications terminal as soon as it has been received from the mailbox servers.

42. The method of claim 29, characterized in that the collected, subscriber-specific status information is transmitted to the respective subscriber with the aid of the “Message Waiting Indication” service feature, which is configured in accordance with the ETSI standard.
